(19) United States
(12) Patent Application Publication
(10) Pub. No.: US 2018/0223078 A1
(43) Pub. Date: Aug. 9, 2018

(54) POLYESTER COMPOSITION

(71) Applicant: Synvina C.V., Amsterdam (NL)

(72) Inventors: Hajime Nakajima, Amsterdam (NL); Jesper Gabriël Van Berkel, Amsterdam (NL); Jeffrey John Kolstad, Amsterdam (NL)

(21) Appl. No.: 15/749,799

(22) PCT Filed: Aug. 4, 2016
(86) PCT No.: PCT/NL2016/050569

§ 371 Date: Feb. 2, 2018

Related U.S. Application Data
(60) Provisional application No. 62/200,704, filed on Aug. 4, 2015.

(30) Foreign Application Priority Data
Aug. 4, 2015 (NL) 2015265

(51) Int. Cl. C08K 5/527; C08L 67/02

(52) U.S. Cl. CPC C08K 5/527; C08L 67/02

(57) ABSTRACT

A polyester composition includes poly(alkylene furandicarboxylate) and a color-stabilizing agent. The poly(alkylene furandicarboxylate) may be poly(ethylene 2,5-furandicarboxylate). Suitable examples of the color-stabilizing agent in such a composition include the compounds selected from a sterically hindered phenolic compound, a phosphonite compound, a phosphite and combinations thereof. In particular the color-stabilizing agent is a phosphite containing at least one tri-substituted phenyl moiety.

### CROSS-REFERENCE TO RELATED APPLICATIONS

This application is the National Stage of International Application No. PCT/NL2016/050569, filed Aug. 4, 2016, which claims the benefit of Netherlands Application No. NL 2015265, filed Aug. 4, 2015, and the benefit of U.S. Provisional Application No. 62/200,704, filed Aug. 4, 2015, the contents of all of which are incorporated by reference herein.

### FIELD OF THE INVENTION

The present invention relates to a polyester composition comprising poly(alkylene furandicarboxylate) and an additive.

### BACKGROUND OF THE INVENTION

Poly(alkylene furandicarboxylate) has been developed as a polyester with advantageous properties. As monomers use is made of an alkylene glycol and furandicarboxylic acid, in particular 2,5-furandicarboxylic acid. 2,5-Furandicarboxylic acid (2,5-FDCA) is a diacid that can be produced from natural sources such as carbohydrates. Routes for its preparation using air oxidation of 2,5-disubstituted furans such as 5-hydroxymethylfurfural or ethers thereof with catalysts comprising Co and Mn have been disclosed in e.g. WO2010/132740, WO2011/043660 and WO2011/043661.

U.S. Pat. No. 2,551,731 describes the preparation of polyesters and polyester-amides by reacting glycols with dicarboxylic acids of which at least one contains a heterocyclic ring, such as 2,5-FDCA. Under melt polymerization conditions, using sodium- and magnesium methoxide as a catalyst, 2,5-FDCA or 2,5-FDCA dimethyl ester and 1.6 equivalents of ethylene glycol were reacted in an esterification step or transesterification step, respectively, at ambient pressure between 160 and 220° C., after which a polycondensation was carried out between 190 and 220° C. under a few mm Hg pressure. The product had a reported melting point of 205-210° C. and readily yielded filaments from the melt.

In WO 2013/120989 a continuous process for the preparation of poly(ethylene furandicarboxylate) is described wherein 2,5-FDCA or a diester thereof is mixed with ethylene glycol at elevated temperature to give a paste or a homogeneous solution, the paste or solution is converted to an esterification product of 2,5-FDCA and ethylene glycol, the esterification product is polycondensed under reduced pressure, wherein the polycondensation is performed in two stages. In an example the polycondensation product was reported to have an intrinsic viscosity of 1.05 dL/g.

In WO 2010/077133 a process for preparing furandicarboxylate-containing polyesters is described wherein the diester of 2,5-FDCA is transesterified with a diol, and the ester composition thus obtained is subjected to polycondensation. The polycondensate may then be subjected to solid state polymerization. In the above-mentioned WO 2010/077133 it is observed that the production of poly(alkylene furandicarboxylate polyester often results in colored products. The invention of WO 2010/077133 is based on the finding that colorless material can be produced. Such colorless material can be used for the production of e.g. bottles as disclosed in WO 2013/062408. This application WO 2013/062408 discloses a process, wherein the dimethyl ester of 2,5-FDCA is transesterified with ethylene glycol, or bis(2-hydroxyethyl)-2,5-furandicarboxylate is used as starting material. The transesterification product or this starting material is then subjected to polycondensation and after a drying/crystallization step the polycondensate is subjected to solid state polymerization to enhance the molecular weight of the polycondensate. The product may be used as water bottles, fibers or films.

Also KR 20140003167 describes a polyester polymer with excellent transparency which is manufactured by using a biomass originated furandicarboxylate ester compound with ethylene glycol. The polyesters thus produced yield b* values in the range of 6 to 10. In comparative examples also furandicarboxylic acid has been used. These polyesters have more color and have b* values in the range 25 to 34.

In US 2012/0207956 polyesters are described, having a 2,5-furandicarboxylate moiety within the polymer backbone and having a degree of polymerization of 185 or more and 600 or less. These polymers are made in a three step process involving the esterification of the 2,5-FDCA or the transesterification of the diester thereof with a diol, and a second step involving polycondensation, followed by solid state polymerization as third step. The color of the polyesters is not mentioned. The polyester obtained may be blended with additives, such as flame retardants, colorants, antioxidants, UV stabilizers and various fillers. Since the polyesters are stated to be used in toner containers, ink tanks and structural material for copiers and printers, it is evident that the color of the polyester is not considered an important feature.

### SUMMARY OF THE INVENTION

However, the colorless polyester is prone to become colored on heat treatment. Such treatment may e.g. involve the extrusion of the polyester to form pellets or to form preforms for the manufacture of blow molded articles. It is an objective of the present invention to retain the lack of coloring during operations of the polyester. Accordingly, the present invention provides a polyester composition comprising poly(alkylene furandicarboxylate) and a color-stabilizing agent.

### DETAILED DESCRIPTION OF THE INVENTION

The poly(alkylene furandicarboxylate) typically comprises 2,5-FDCA as diacid building block and an alkylene glycol, or a mixture of alkylene glycols, as diol building blocks. The alkylene glycol may be selected from the group consisting of C₂-C₁₀ alkylene glycol, suitably from the group consisting of C₂-C₆ alkylene glycols, more preferably from the group consisting of C₂-C₄ alkylene glycol. Most preferably, the alkylene glycol is ethylene glycol. The amount of alkylene glycol is suitably in the range of 100 to 95 mol %, based on the molar amount of diacid building blocks. If the amount of alkylene glycol is less than 100 mol %, the remaining diol building blocks may comprise dialkylene glycol, such as diethylene glycol, trialkylene glycol, isosorbide, erythritol or mixtures thereof. Preferably, the poly(alkylene furan dicarboxylate) comprises substantially 100% alkylene glycol as diol building blocks. Suitably, the diacid building blocks of the polyester consists for at least 95 mol % of 2,5-FDCA, i.e. 2,5-furandicarboxylic acid. The remaining 5 mol % may comprise other diacids, such as terephthalic acid, isophthalic acid, azelaic acid, adipic acid, sebacic acid, succinic acid, 1,4-dicyclohexane dicarboxylic acid, maleic acid and mixtures thereof. Preferably, the poly(alkylene furan dicarboxylate) comprises a poly(alkylene 2,5-furandicarboxylate). The poly(alkylene 2,5-furandicarboxylate) suitably comprises only 100% 2,5-FDCA as diacid building blocks. Since the diol preferably comprises ethylene glycol, the poly(alkylene furandicarboxylate) is preferably poly(ethylene 2,5-furandicarboxylate).

The color-stabilizing agent can be selected from a wide variety of chemical compounds. It has been found that some antioxidants may have a beneficial effect on the color stability of the polyester composition. However, common antioxidants are sterically hindered phenolic compounds. It has been found that although these compounds are very commonly used in various polyesters, the use of these compounds is not preferred in poly(alkylene furandicarboxylate) resins.

If applied, the sterically hindered phenolic compound suitably contains at least one tertiary alkyl group at the 2 position. Suitable phenolic compounds are represented by formula (I)

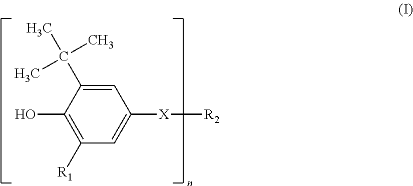

wherein R₁ is a linear or branched C₁-C₁₀ alkyl group;
n is an integer of 1 to 4;
X represents —CH₂—, —CH₂—C(O)—Y—, —CH₂—CH₂—C(O)—Y—, —CH₂—C(O)—O—CH₂—, or —CH₂—C(O)—O—CH₂—CH₂—;

### Y is —O— or —NH—; and

when n is 1, R₂ is C₁-C₂₀ alkyl;
when n is 2, R₂ is C₂-C₁₂ alkylene, C₂-C₂₀ alkylene, wherein one or more methylene groups are replaced by oxygen or sulfur atoms; and
when n is 3, R₂ is 1,3,5 triazinetrione.

R₁ is suitably methyl or t-butyl.

Suitable examples of R₂ include C₁-C₂₅ alkyl, preferably C₁-C₁₈ alkyl, for example C₄-C₁₈ alkyl. An especially preferred definition of R₂ is C₁-C₂₅ alkyl, more preferred C₈-C₁₈ alkyl, especially C₁₄-C₁₈ alkyl, for example C₁₈ alkyl. The alkyl group may be linear or branched, such as n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl.

When n is 2, suitable examples of R₂ include ethylene, propylene, tetramethylene, pentamethylene, hexamethylene, heptamethylene, octamethylene, decamethylene and dodecamethylene. R₂ may comprise oxygen or sulfur atoms, such as in —CH₂—O—CH₂—CH₂—O—CH₂—, —CH₂—(O—CH₂—CH₂—)₂—O—CH₂—, —CH₂—(O—CH₂—CH₂—)₃—O—CH₂—, —CH₂—(O—CH₂—CH₂—)₄—O—CH₂—, —CH₂—CH₂—O—CH₂—CH₂—O—CH₂—CH₂— or —CH₂—CH₂—S—CH₂—CH₂—.

As indicated, the use of sterically hindered phenolic compounds alone is not preferred.

The color-stabilizing agent is preferably selected from the group consisting of phosphonite compounds, phosphites and combinations thereof.

When the color-stabilizing agent is a phosphonite compound, the phosphonite compound may be aliphatic or aromatic. Suitably the phosphonite compounds are aromatic. Examples of suitable phosphonite compounds are represented by formula (II)

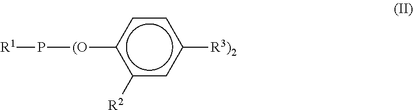

wherein R¹ is alkyl with 1 to 18 carbon atoms, phenyl or phenyl substituted by 1 to 3 alkyl groups with 1 to 8 carbon atoms in each alkyl group, diphenyl or diphenyl substituted at the 4′-position by the phosphonite moiety

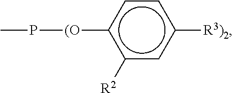

R² is tertiary alkyl with 4 to 18 carbon atoms, benzyl, α-methylbenzyl or α,α-dimethylbenzyl, and R³ is hydrogen, branched or linear alkyl of 1 to 18 carbon atoms, benzyl, α-methylbenzyl or α,α-dimethylbenzyl. Preferably, R² and R³ are both tertiary alkyl groups with 4 to 8 carbon atoms, in particular t-butyl. R¹ is preferably a diphenyl group substituted with a phosphonite moiety at the 4′-position. Most preferably, the phosphonite compound comprises a diphenyl group with as substituents at the 4- and 4′-positions two identical phosphonite moieties wherein R² and R³ are tertiary alkyl with 4 to 8 carbon atoms, most preferably t-butyl.

Preferably, the color-stabilizing agent is a phosphite. Although trialkylphosphites can be used, such as tris(C₁-C₁₂ alkyl)phosphite, e.g. trimethyl phosphite, tributylphosphites, trioctyl phosphite or trinonyl phosphite, it is preferred to use aromatic phosphites. The phosphites therefore preferably contain two or more, optionally substituted, phenyl groups. The substituents in the phenyl groups are suitably selected from linear or branched C₁-C₁₈ alkyl groups. More preferably, the substituents are tertiary alkyl groups with 4 to 8 carbon atoms, in particular t-butyl. Suitably, the phosphite contains at least one tri-substituted phenyl moiety. The phosphite suitably is a compound of formula R′-Q-R″, wherein Q represents a pentaerythritol-phosphite group of formula (III).

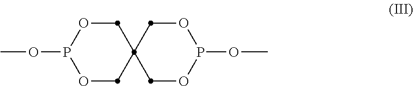

and wherein R′ and R″ aliphatic, cycloaliphatic or aromatic organic groups. R′ and R″ are suitably a linear or branched alkyl group with 1 to 30 carbon atoms, preferably from 5 to 25, more preferably from 8 to 20 carbon atoms. Alternatively, the groups R′ and R″ are cycloaliphatic groups, such as an optionally substituted cyclohexyl group, which may suitably be substituted with one or more linear or branched alkyl groups having 1 to 20 carbon atoms. Preferably, the groups R′ and R″ are aromatic groups, more suitably phenyl groups, which may contain 1 to 5 substituents. Preferably, the phenyl groups comprise 2 to 5 substituents, more preferably 3 or 4 substituents. The substituents are suitably selected from linear or branched alkyl groups having 1 to 20 carbon atoms, more preferably tertiary alkyl groups with 4 to 10 carbon atoms, most preferably t-butyl. When the phenyl group contains 3 substituents the substituents are suitably positioned on the 2, 4 and 6 position of the phenyl ring. Most preferably, the color-stabilizing agent is a phosphite of the formula R′-Q-R″, wherein Q represents a pentaerythritol-phosphite group of formula (III).

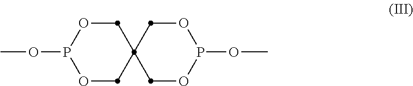

and wherein R′ and R″ are 2,6-di(t-butyl)-4-methyl-phenyl groups.

As the color-stabilizing agent that is used in the present invention is very effective, the amount thereof in the polyester composition according to the invention can be low. Typically amounts of color-stabilizing agents as low as 0.01% wt based on the composition may already be effective. For polyester compositions that are to be subjected to heat treatment, an amount of color-stabilizing agent may be up to 5% wt. Thus the amount of color-stabilizing agent in the composition may suitably be in the range of 0.01 to 5% wt, more preferably in the range of 0.03 to 4% wt, most preferably in the range of 0.05 to 2.5% wt, all weight percentages based on the weight of the poly(alkylene furandicarboxylate) and color-stabilizing agent. On the other hand it has been found advantageous to prepare masterbatches of the polyester composition of the present invention that can be used to be added to poly(alkylene furandicarboxylate) to arrive at the desired concentration. The amount of the color-stabilizing agent in the masterbatch can be as high as 50% wt, whereas suitably the amount is up to 25% wt, based on the weight of the poly(alkylene furandicarboxylate) and color-stabilizing agent. A minimum amount of a masterbatch may be as low as 5% wt. The amount of color-stabilizing agent in polyester compositions can therefore range from 0.01 to 50% wt, preferably from 0.03 to 25% wt, based on the weight of the poly(alkylene furandicarboxylate) and color-stabilizing agent.

As indicated above, the poly(alkylene furandicarboxylate) can contain C₂-C₁₀ alkylene groups, suitably C₂-C₆ alkylene groups, more preferably C₂-C₄ alkylene groups. Most preferably, the poly(alkylene furandicarboxylate) is poly(ethylene 2,5-furandicarboxylate). It has been found that the end groups of the polyester chains have an influence on the effectiveness of the color-stabilizing agent. The end groups can be selected from the group consisting of a carboxylic end group, a hydroxyl end group, a methyl ester end group and a furoic acid end group. The latter may be obtained owing to decarboxylation in the polymerization process. When the poly(alkylene furandicarboxylate) is poly(ethylene 2,5-furandicarboxylate) it has been found advantageous that the poly(ethylene 2,5-furandicarboxylate) has a carboxylic end group content in the range of 0 to 122 meq/kg, preferably from 2 to 100 meq/kg. The carboxylic acid end groups are determined by using the titration method according to ASTM D7409, adapted for poly(ethylene 2,5-furan-dicarboxylate). A thus modified method thereof involves the titration of a 4% w/v solution of poly(ethylene 2,5-furandicarboxylate) in ortho-cresol with 0.01M KOH in ethanol as titrant to its equivalence point, using 0.5 mg of bromocresol green (2,6-dibromo-4-[7-(3,5-dibromo-4-hydroxy-2-methyl-phenyl)-9,9-dioxo-8-oxa-9λ6-thiabicyclo[4.3.0]nona-1,3,5-trien-7-yl]-3-methyl-phenol) in 0.1 ml ethanol as indicator.

In addition the polyethylene 2,5-furandicarboxylate has a hydroxyl end group content in the range of 30 to 200 meq/kg and/or a furoic acid end group content in the range of 0 to 15 meq/kg.

In general there are a number of methods to determine the end groups in polyesters. Such methods include titration, infrared and nuclear magnetic resonance (NMR) methods. Often the separate methods are used to quantify the four main end groups: carboxylic acid end groups, hydroxyl end groups, alkyl ester groups, such as the methyl ester end groups (for polyesters from the dialkyl ester of a dicarboxylic acid) and the end groups that are obtained after decarboxylation. A. T Jackson and D. F. Robertson have published an ¹H-NMR method for end group determination in “Molecular Characterization and Analysis of Polymers” (J. M. Chalmers en R. J. Meier (eds.), Vol. 53 of “Comprehensive Analytical Chemistry”, by B. Barcelo (ed.), (2008) Elsevier, on pages 171-203. In this method the hydroxyl end group is determined in polyethylene terephthalate (PET) by using a selection of harsh solvents such as 3-chlorophenol, 1,1,1,3,3,3-hexafluoro-2-propanol, trichloroacetic acid or trifluoroacetic acid. It is preferred to use deuterated 1,1,2,2-tetrachloroethane (TCE-d2) as solvent without any derivatization of the polyester. A similar method can be carried out for polyesters that comprise furandicarboxylate moieties and ethylene glycol residues. The measurement of the end groups for the latter polyesters can be performed at room temperature without an undue risk of precipitation of the polyester from the solution. This ¹H-NMR method using TCE-d2 is very suitable to determine the hydroxyl end groups (HEG) and the furoic acid end groups, also known as decarboxylation end groups (DecarbEG). Peak assignments are set using the TCE peak at a chemical shift of 6.04 ppm. The furan peak at a chemical shift of 7.28 ppm is integrated and the integral is set at 2.000 for the two protons on the furan ring. The HEG is determined from the two methylene protons of the hydroxyl end group at 4.0 ppm. The content of DEG is determined from the integral of the shifts at 3.82 to 3.92 ppm, representing four protons. The decarboxylated end groups are found at a shift of 7.64-7.67 ppm, representing one proton. When the polyester also comprises methyl ester end groups, the methyl signal will occur at about 3.97 ppm, representing 3 protons.

The poly(ethylene 2,5-furandicarboxylate) may have a relatively high molecular weight. The molecular weight is expressed in terms of intrinsic viscosity. First the relative viscosity (ηᵣₑₗ) is determined in a 60/40 w/w mixture of phenol and tetrachloroethane at 30° C. and a concentration (c) of 0.4 g/dL. This procedure is similar to the ASTM D4603 standard for the determination of the inherent viscosity for poly(ethylene terephthalate). The intrinsic viscosity is then calculated using the Billmyer equation:

Intrinsic viscosity (IV)={ηᵣₑₗ−1+3*ln(ηᵣₑₗ)}/(4*c)

The poly(ethylene 2,5-furandicarboxylate) has typically been subjected to solid state polymerization, also known as solid stating. Due to solid stating the molecular weight is increased such as to 0.65 to 1.2 dL/g, preferably to an intrinsic viscosity of at least 0.75 dL/g, more preferably in the range of 0.75 dL/g to 1.2 dL/g.

The poly(ethylene 2,5-furandicarboxylate) is typically a semi-crystalline polyester. Polymer crystallinity can be determined with Differential Scanning Calorimetry (DSC) by quantifying the heat associated with melting of the polymer. The heat can be reported as the percentage of crystallinity by normalizing the melting heat to that of a 100% crystalline sample. However, those samples are rare. Therefore, the crystallinity is often expressed as net enthalpy in terms of number of Joules per gram which number is derived from the DSC technique. The enthalpy of melting and crystallization can be determined in accordance with ISO 11357-3. The poly(ethylene 2,5-furandicarboxylate) in the composition according to the invention suitably has a crystallinity of at least 25 J/g, preferably of at least 40 J/g, measured by DSC. The crystallinity will then advantageously be in the range of 40 to 90 J/g.

The melting point of a polymer is easily determined by DSC and measured at the top of the endothermic peak. The ISO11357-3 standard describes such a melting point determination. In accordance with this determination, the poly(ethylene 2,5-furan-dicarboxylate) suitably has a melting point of at least 200° C. In highly crystalline polyester the melting point may exceed 230° C. and may be as high as 245° C. It suitably has a melting point of at least 200° C., preferably at least 215° C.

Acetaldehyde may be formed during the polycondensation process in the preparation of poly(ethylene 2,5-furandicarboxylate). Its content in polyester compositions can be determined using known methods. A suitable method is described in ASTM F 2013; this is described for polyethylene terephthalate, but can also be used for the polyester composition of the present invention. Applicants have found that polyester compositions can have acetaldehyde values of 18 mg/kg or higher, prior to the additional steps of solid state polymerization. Applicants have also found that a suitable solid state polymerization process can reduce the levels of acetaldehyde. Such a suitable solid state polymerization process comprises heating a semi-crystalline starting polyester comprising ethylene 2,5-furandicarboxylate units, and having a melting point Tm, at a temperature in the range of (Tm−40° C.) to Tm to obtain a solid stated polyester, wherein the semi-crystalline starting polyester has an intrinsic viscosity of at least 0.45 dL/g, and an amount of carboxylic acid end groups in the range of 15 to 122 meq/kg. It has been found that the solid stated poly(ethylene 2,5-furandicarboxylate) thus obtained has a reduced acetaldehyde level, e.g. to less than 1 mg/kg (ppm) and preferably to less than 0.5 mg/kg, calculated as acetaldehyde per kg poly(ethylene 2,5-furandicarboxylate).

As is taught in U.S. Pat. No. 6,569,479 acetaldehyde is naturally formed during processing of any polyester containing ethylene glycol linkages. The compound is formed via a two-step reaction: the first step is cleavage of a polymer chain, generating a vinyl end group and a carboxylic acid end group. The second step is reaction of the vinyl end group with a hydroxyethyl end group, reforming the polymer chain and releasing acetaldehyde. When the polymer is used in a container for beverages, the acetaldehyde may migrate from the container sidewall into the beverage over time. During the lifetime of a typical container, several hundred ppb of acetaldehyde can migrate from the container sidewall into the beverage. For sensitive products, such as water, these levels of acetaldehyde are significantly above the taste threshold. In U.S. Pat. No. 4,340,721 it is shown that when polyethylene terephthalate contains more than 1 ppm acetaldehyde, the polymer is unsuitable for use as material for beverage containers. Therefore there is a great desire to limit the amount of acetaldehyde in polyesters comprising ethylene furandicarboxylate units also to a level below 1 ppm (mg acetaldehyde per kg polyester). The composition according to the invention preferably contains poly(ethylene 2,5-furandicarboxylate) having an acetaldehyde content of at most 1 mg/kg, preferably at most 0.5 mg/kg.

The invention is further illustrated by means of the following examples.

### Example 1

In a series of experiments 1000 ppmw of a color-stabilizing agent was mixed with a poly(ethylene 2,5-furandicarboxylate). The mixture was passed through an extruder at a temperature of 255° C. at a screw rotation of 50 rpm and for a period of 40 sec. The resulting polyester was checked for color. The color is expressed in terms of absorbance (A, %). The light absorbance was measured as a 30 mg/mL solution in a dichloromethane:hexafluoroisopropanol 8:2 (vol/vol) mixture at 400 nm. Alternatively, the b* value was determined using the CIE L*a*b* method. For comparison purposes a separate sample of the poly(ethylene 2,5-furandicarboxylate) was extruded under the same conditions without any color-stabilizing agent. The results are shown in Table 1 below.

TABLE 1

| Exp. | | A, | |
|---|---|---|---|
| No. | Color-stabilizing agent | % | b* |
| 1 | — | 2.4 | 5.8 |
| 2 | 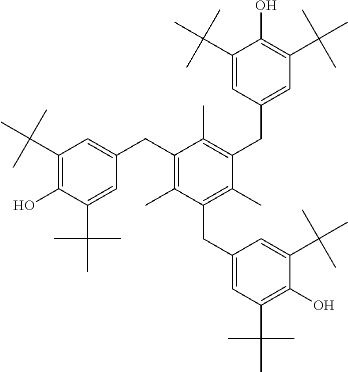 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] | 3.0 | — |
| 3 | 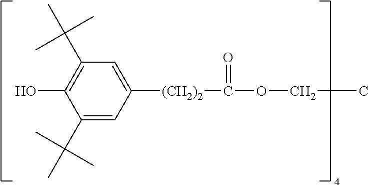 | 2.4 | 6.0 |
| 4 | 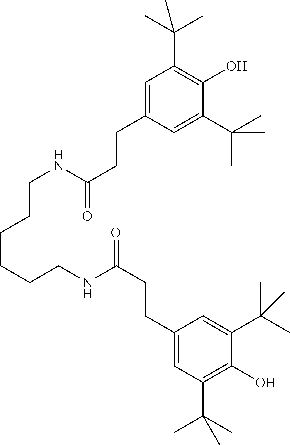 [SMILES: CC(C)(C)c1cc(CCC(=O)NCCCCCCNC(=O)CCc2cc(C(C)(C)C)c(O)c(C(C)(C)C)c2)cc(C(C)(C)C)c1O] | 3.6 | — |
| 5 | 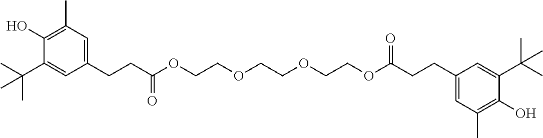 [SMILES: Cc1cc(CCC(=O)OCCOCCOCCOC(=O)CCc2cc(C)c(O)c(C(C)(C)C)c2)cc(C(C)(C)C)c1O] | 3.0 | — |
| 6 | 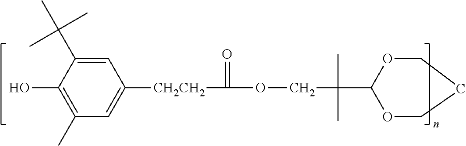 | 2.5 | — |
| 7 | 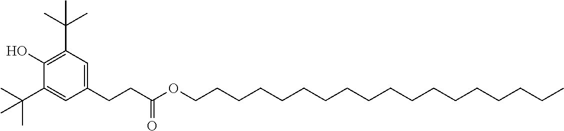 [SMILES: CCCCCCCCCCCCCCCCCCOC(=O)CCc1cc(C(C)(C)C)c(O)c(C(C)(C)C)c1] | 2.6 | 6.4 |
| 8 | 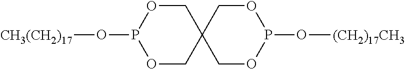 | 2.4 | 7.0 |
| 9 | 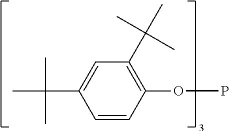 | 2.4 | 5.8 |
| 10 | 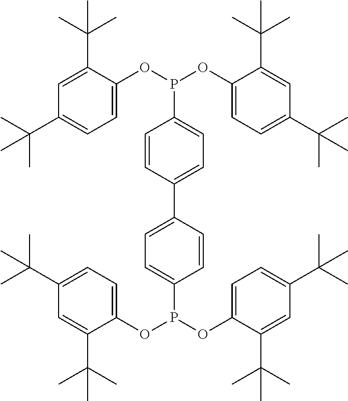 [SMILES: CC(C)(C)c1ccc(OP(Oc2ccc(C(C)(C)C)cc2C(C)(C)C)c2ccc(-c3ccc(P(Oc4ccc(C(C)(C)C)cc4C(C)(C)C)Oc4ccc(C(C)(C)C)cc4C(C)(C)C)cc3)cc2)c(C(C)(C)C)c1] | 2.2 | 5.3 |
| 11 | 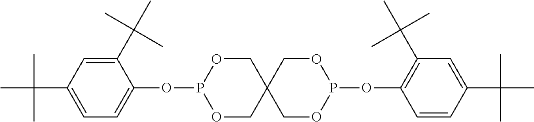 [SMILES: CC(C)(C)c1ccc(OP2OCC3(CO2)COP(Oc2ccc(C(C)(C)C)cc2C(C)(C)C)OC3)c(C(C)(C)C)c1] | 2.6 | 6.3 |
| 12 | 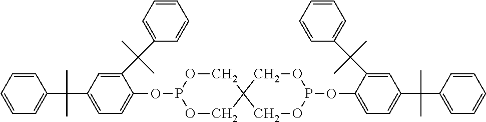 [SMILES: CC(C)(c1ccccc1)c1ccc(OP2OCC3(CO2)COP(Oc2ccc(C(C)(C)c4ccccc4)cc2C(C)(C)c2ccccc2)OC3)c(C(C)(C)c2ccccc2)c1] | 2.5 | 6.1 |
| 13 | 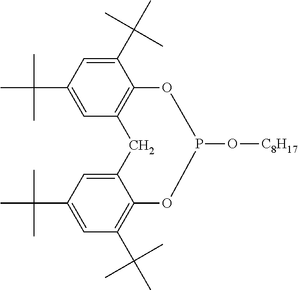 | 2.7 | — |
| 14 | 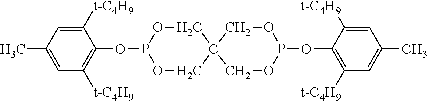 | 2.1 | 5.4 |
| 15 | 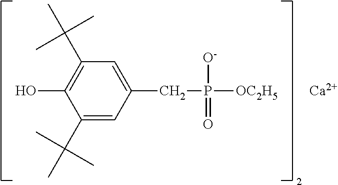 | 2.5 | 6.2 |

The above results show that the phosphonite compound of Exp. No. 10 and the phosphite of Exp. No. 14 gave the best results. The Exp. Nos. 2 to 7 using sterically hindered phenolic compounds, all resulted in more colored products than blank Exp. No. 1.

### Example 2

To study the effect of prolonged exposure to heat, the mixtures of Exp. Nos. 9, 10 and 14 were passed through the extruder three times, so that an exposure to 255° C. for a period of 120 sec was obtained. The color of the resulting mixtures was again determined as in Example 1, and compared with the results of a blank experiment. The results are shown in Table 2.

TABLE 2

| Exp. | | A, | |
|---|---|---|---|
| No | Color stabilizing agent | % | b* |
| 16 | — | 3.9 | 9.5 |
| 17 | 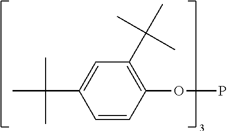 | 3.7 | 9.0 |
| 18 | 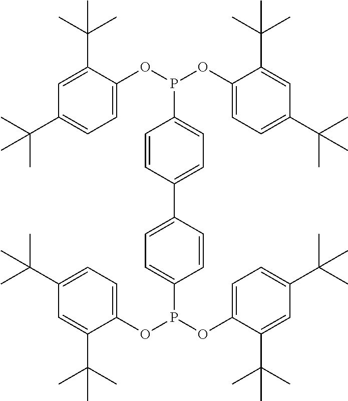 [SMILES: CC(C)(C)c1ccc(OP(Oc2ccc(C(C)(C)C)cc2C(C)(C)C)c2ccc(-c3ccc(P(Oc4ccc(C(C)(C)C)cc4C(C)(C)C)Oc4ccc(C(C)(C)C)cc4C(C)(C)C)cc3)cc2)c(C(C)(C)C)c1] | 4.0 | 9.5 |
| 19 | 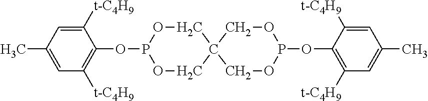 | 3.2 | 7.9 |

The results show that the phosphites of Exp. No. 17 and 19 give better results at prolonged exposure to heat than the phosphonite of Exp. No. 18.

### Example 3

To show the effect of combinations of phosphites with sterically hindered phenolic compounds, the phosphites of Exp. Nos. 9 and 14 were combined with the sterically hindered phenolic compound of Exp. No. 3. The relative proportions of the agents were varied, whereas the total amount of the combination of agents was 1000 ppmw.

The combinations were mixed with the poly(ethylene 2,5-furandicarboxylate) and subsequently treated in the same way as the mixtures in Example 1. The results are shown in Table 3.

TABLE 3

| Exp. | | | | | A, | |
|---|---|---|---|---|---|---|
| No. | Phosphite | prop | Phenolic compound | prop | % | b* |
| 20 | 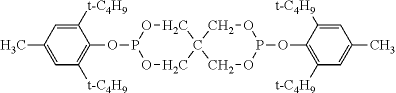 | 0.75 | 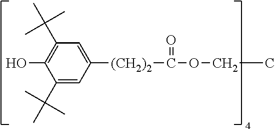 | 0.25 | 2.3 | 5.6 |
| 21 | -same- | 0.5 | -same- | 0.5 | 2.6 | 6.4 |
| 22 | -same- | 0.25 | -same- | 0.75 | 2.6 | 6.4 |
| 23 | 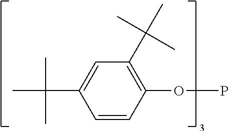 | 0.5 | -same- | 0.5 | 2.4 | 5.9 |

A comparison between the results of Experiment No. 14 with those of Experiment Nos. 20-22 shows that when a proportion of the phosphite of Experiment No. 14 is replaced by a sterically hindered phenolic compound, the color-stabilizing effect of the combination is virtually as good as the effect of the phosphite alone. The same is the case when apportion of the phosphate of Experiment No. 9 is replaced by a sterically hindered phenolic compound (cf. Experiment Nos. 9 and 23).

1. A polyester composition comprising poly(alkylene furandicarboxylate) and a color-stabilizing agent.

2. The composition according to claim 1, wherein the color-stabilizing agent is selected from the group consisting of sterically hindered phenolic compounds, phosphonite compounds, phosphites and combinations thereof.

3. The composition according to claim 2, wherein the color-stabilizing agent comprises a phosphonite compound, a phosphite or a combination thereof.

4. The composition according to claim 3, wherein the color-stabilizing agent comprises a phosphite containing at least one tri-substituted phenyl moiety.

5. The composition according to claim 1, wherein the color-stabilizing agent is a phosphite of the formula R′-Q-R″, wherein Q represents a pentaerythritol-phosphite group of formula (III) 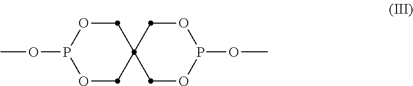
and wherein R′ and R″ are 2,6-di(t-butyl)-4-methyl-phenyl groups.

6. The composition n according to claim 1, wherein the color-stabilizing agent is present in an amount ranging from 0.01 to 50% wt, preferably from 0.03 to 25% wt, based on the weight of the poly(alkylene furandicarboxylate) and color-stabilizing agent.

7. The composition according to claim 1, wherein the poly(alkylene furandicarboxylate) is poly(ethylene 2,5-furandicarboxylate).

8. The composition according to claim 7, wherein the poly(ethylene 2,5-furan-dicarboxylate) has a carboxylic end group content in the range of 0 to 122 meq/kg.

9. The composition according to claim 7, wherein the poly(alkylene furandicarboxylate) is poly(ethylene 2,5-furandicarboxylate) having a hydroxyl end group content in the range of 30 to 200 meq/kg and/or a furoic acid end group content in the range of 0 to 15 meq/kg.

10. The composition according to claim 7, wherein the poly(ethylene 2,5-furandicarboxylate) has a molecular weight expressed as intrinsic viscosity (IV) of at least 0.75 dug, preferably an IV in the range of 0.75 to 1.2 dL/g.

11. The composition according to claim 7, wherein the poly(ethylene 2,5-furandicarboxylate) has a crystallinity of at least 40 J/g, measured by Differential Scanning Calorimetry (DSC).

12. The composition according to claim 7, wherein the poly(ethylene 2,5-furandicarboxylate) has a melting point of at least 215° C.

13. The composition according to claim 7, wherein the poly(ethylene 2,5-furandicarboxylate) has an acetaldehyde content of at most 1 mg/kg, preferably at most 0.5 mg/kg.
